(19) United States
(12) Patent Application Publication
(10) Pub. No.: US 2004/0129841 A1
(43) Pub. Date: Jul. 8, 2004

(54) Drop wire clamp

(75) Inventor: George J. Franks JR., Inverness, IL (US)

Correspondence Address: FITCH EVEN TABIN AND FLANNERY, 120 SOUTH LA SALLE STREET, SUITE 1600, CHICAGO, IL, 60603-3406, US

(73) Assignee: SENIOR INDUSTRIES, INC.

(21) Appl. No.: 10/738,234

(22) Filed: Dec. 17, 2003

Related U.S. Application Data
(63) Continuation-in-part of application No. 10/225,923, filed on Aug. 22, 2002, now Pat. No. 6,732,981.

(51) Int. Cl. F16L 3/00

(52) U.S. Cl. 248/58

(57) ABSTRACT

A clamp designed to accept and secure a cable with a securing wire. The clamp may include an insulating insert or insulator coating on at least a portion of the hanger portion of the clamp which electrically insulates the clamp at the attachment point to a structure. The insulator material has properties sufficient to withstand both the high weight loads and forces on the contact point between the drop wire clamp and the attachment point and the slight swinging or rubbing action between the drop wire clamp and the attachment point caused by the wind. The attachment structure, such as a hook or fastener, at the attachment point may also be provided with an insulator coating.

### CROSS-REFERENCE TO RELATED APPLICATION

This application is a continuation-in-part of application Ser. No. 10/225,923, filed on Aug. 22, 2002.

### FIELD OF THE INVENTION

The present invention is directed to a drop wire clamp for suspending and directing a cable and, more particularly, to an improved drop wire clamp which is electrically insulated at the attachment point to a structure, such as a building, wall, pole, or the like.

### BACKGROUND OF THE INVENTION

Various types of clamps are employed to support and direct cables extending between supports and structures, such as from a utility pole to a building. One common type of clamp is referred to as a drop-wire clamp. Such clamps are typically used with cables having two strands, a signal-carrying strand and a support strand (also referred to as a messenger wire). A drop-wire clamp allows a cable, such as coaxial cable, to be supported and attached to a building, pole, or other support in a manner that lessens the compromise of the signal transmission capability of the cable. A drop-wire clamp also is advantageous because it supports the weight of the cable and maintains tension on the wire or cable while relieving stress on the attachment points, such as at the attachment juncture with a pole or building.

Drop-wire clamps tend to fall into two general categories: (1) a wire wrap type; and (2) a compression type. In a wire wrap-type drop wire clamp, a portion of the messenger strand is separated from the signal carrying strand and wrapped around the clamp to secure the cable to the clamp. In a compression-type drop wire clamp, the cable is secured to the clamp through pressure. In either design, it is critical that the clamp does not degrade the signal quality by damaging either the signal carrying cable or its insulation.

More specifically, a wire wrap-type drop-wire clamp utilizes a trough that accepts the signal-carrying strand. The trough is generally wider than the cable so as to receive it with a loose fit and, thus, avoid signal effecting damage to the signal carrying strand. Due to the loose fit between the signal carrying strand and the trough, the messenger wire is employed to secure the signal carrying strand in the trough of the clamp. Typically, these clamps have notches on the sides so that the wire is wrapped transversely about the clamp and is maintained in place by the notches or slots. This wrap holds the signal carrying strand in the clamp. Examples of prior wire wrap-type clamps are disclosed in U.S. Pat. Nos. 5,209,439 and D342,664.

A shortcoming with the wire wrap-type clamps, including those disclosed in U.S. Pat. Nos. 5,209,439 and D342,664, is that the user must alternate between hands when wrapping the messenger wire transversely around the trough and/or constantly remove the hand from the messenger wire to grab the messenger wire on the other side of the cable and clamp to compete the transverse wrap. More specifically, for example, one hand is used to hold the clamp, while the other hand is used wrap the messenger wire part way around the clamp. The user must then switch hands to complete the wrap, i.e., the other hand is used to grasp the clamp while the first hand is used to complete the wrap. This hand-alternating procedure is duplicated for each wrap and, thus, can include anywhere from one to four wraps, depending on the desired number of wraps. Although the wire wrap -type clamps address the issue of damage to the signal-carrying wire because of the loose fit between the trough and the wire, it has been found to be cumbersome, time consuming and overall more complicated than desired.

Another known shortcoming of a wire wrap-type clamp is the inflexibility with the manner in which the messenger wire can be wrapped about the trough to secure the signal carrying wire. That is, the design and positioning of the notches and slots commonly dictate only one wrapping pattern for the messenger wire.

A compression-type drop-wire clamp secures the cable using compression. Compression designs may or may not use a trough to accept the signal-carrying wire, but the distinguishing feature of these clamps is that the signal-carrying wire is typically held to the clamp through some type of compressive force or pressure on the wire. Examples of this type of design are disclosed in U.S. Pat. Nos. 3,960,461; 4,461,059; and 4,592,117.

For example, U.S. Pat. No. 3,960,461 discloses a clamp with two concentric cones that sandwich the cable. More specifically, a cable sits in a grove along the exterior of an inner cone and an outer cone or sleeve is slid over the inner cone. Due to the cone shaped surfaces, the cable is sandwiched under compressive pressure. U.S. Pat. No. 4,461,059 discloses a clamp with a trough that accepts the cable; however, the cable is secured in the trough under pressure of several rib members or fins. U.S. Pat. No. 4,592,117 discloses a clamp body that receives a wedge piece that contains a channel for accepting the cable. With the cable sitting in the channel of the wedge piece, it is then slid into the clamp. The cable is secured therein through pressure between the clamp and wedge piece.

Although these compression-type designs may eliminate the complicated wrapping procedure, one known shortcoming is that they may cause damage to the cable through the pressurized contact used to secure the cable to the clamp. This result is also known to disturb the spacing between the core wire and shielding braid.

Thus, there is desired an improved drop-wire clamp that includes the benefits of the wire wrap-type design to minimize damage to the signal-carrying wire, but also allows the cable to be secured into the clamp without complicated messenger wire wrapping procedures.

Additionally, in some instances, it is desirable to prevent an electrical connection between the drop wire clamp and the attachment point to a structure. In particular, it is desirable to insulate such a connection to prevent the transmission of stray electricity, such as from an electrical surge, lightning strike, or frayed wire, to the building, wall, pole, or other like structure through the attachment point. Thus, it may be beneficial to provide a drop wire clamp which is electrically insulated at the attachment point. However, many insulators cannot withstand the high weight loads and forces on the contact point between the drop wire clamp and the attachment point, nor can they withstand the slight swinging or rubbing action between the drop wire clamp and the attachment point that may be caused by the wind without breaking down.

Thus, there is desired an improved drop wire clamp that is electrically insulated at the attachment point on the building, wall, pole, or other like structure wherein the insulator has properties sufficient to withstand both the high weight loads and forces on the contact point with the structure and the slight swinging or rubbing action at the contact point with the structure.

### BRIEF DESCRIPTION OF THE DRAWINGS

FIG. 1 is a perspective view of a drop-wire clamp embodying features of the present invention;

FIG. 2 is a perspective view of the drop-wire clamp of FIG. 1 illustrating attachment to a double-stranded cable;

FIG. 3 is a side elevational view of the drop-wire clamp of FIG. 1 illustrating an alternate attachment to a double-stranded cable;

FIG. 4 is a perspective view of another drop-wire clamp embodying features of the present invention illustrating attachment to a double stranded cable;

FIG. 5 is a side elevational view of the drop-wire clamp of FIG. 4 illustrating attachment to a double-stranded cable;

FIG. 6 is a perspective view of a drop-wire clamp embodying features of the present invention;

FIG. 7 is a side elevational view of the drop-wire clamp of FIG. 6;

FIG. 8 is a perspective view of an insulating insert embodying features of the present invention;

FIG. 9 is a top plan view of the insulating insert of FIG. 8;

FIG. 10 is a side elevational view of the insulating insert of FIG. 8;

FIG. 11 is a cross-sectional view of the insulating insert taken along line A-A of FIG. 9;

FIG. 12 is a cross-sectional view of the insulating insert taken along line B-B of FIG. 9;

FIG. 13 is a cross-sectional view of the insulating insert taken along line C-C of FIG. 9; and

FIG. 14 is a perspective view of a coated drop wire hanger portion embodying features of the present invention.

### DETAILED DESCRIPTION OF THE PREFERRED EMBODIMENT(S)

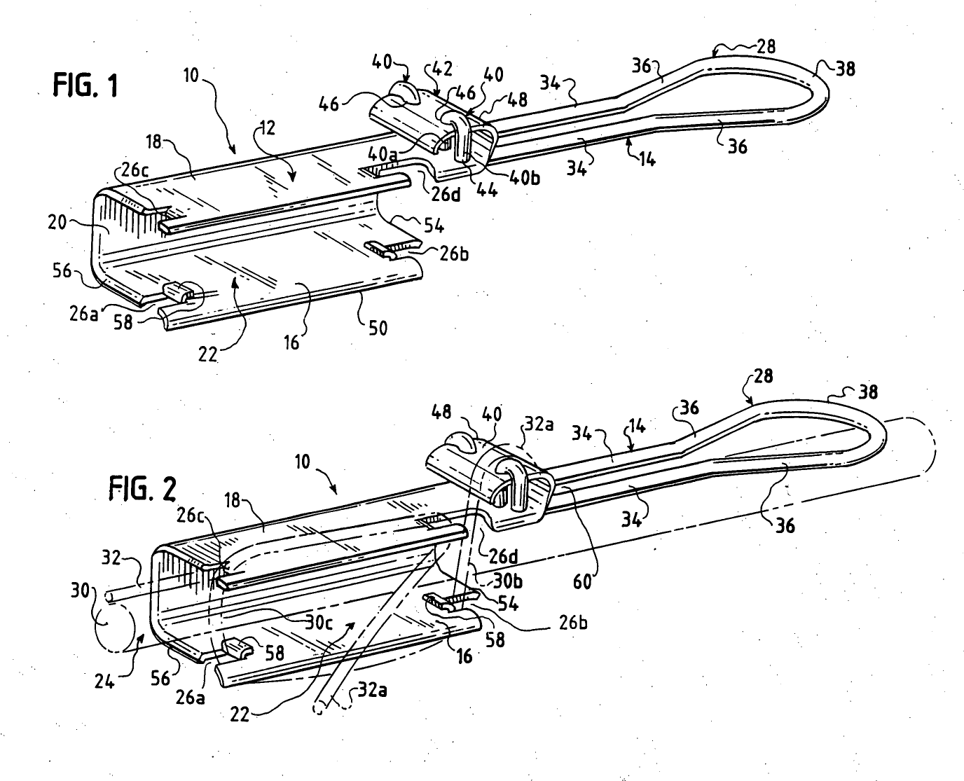

Referring to FIGS. 1-3, there is illustrated a clamp 10 having two pieces, a body 12 and a wire hanger or bail 14. The body 12 includes a first elongated side wall 16 and a second elongated side wall 18 interconnected by an elongated base wall 20. The walls 16, 18, 20 define a cavity or trough 22 that is sized to accept in a generally loose fitting fashion a conventional signal-carrying cable 24. The first side wall 16 includes a rear notch 26a and a front notch 26b. The second side wall 18 includes a rear notch 26c and may include an optional front notch 26d. The notches 26a-c (and 26d when present) open in a direction designed to facilitate expeditious and effective securement of the cable 24 in the clamp 10. The wire hanger 14 includes a loop 28 that enables the clamp 10 to be easily suspended from a hook or other conventional attachment to structure, such as a pole or building.

More specifically, the clamp 10 can be employed to support and direct, in a suspended fashion, cabling (such as cabling in the form of coaxial cable 24 for community antenna television (CATV)) running between structures, including from pole to pole or from a pole to a building, such as a residence. The cable 24 is a double-stranded cable with a signal-carrying wire 30 and an attached support wire or messenger wire 32. To attach the cable 24 to the clamp 10, a portion 32a of the messenger wire 32 is separated from the signal carrying wire 30. The trough 22 of the clamp 10 receives the cable 24 (both the signal-carrying wire 30 and the messenger wire 32), and the separated portion 32a of the messenger wire 32 is used to close off the opening of the trough 22 to secure the cable 24 in the trough 22.

To secure the opening of the trough 22, the separated portion 32a of the messenger wire 32 is wound around the body 12 using the notches 26a-c (and 26d when present) to maintain its position relative to the body 12. Due to the positioning, orientation and configuration of the notches 26a-c, the winding of the separated messenger wire portion 32a can be accomplished quickly and efficiently without having to shift the clamp 10 and wire portion 32a from hand-to-hand. Moreover, as discussed herein, a variety a winding patterns between the separated messenger wire portion 32a and the notches 26a-c (and notch 26d if present) can be employed in securing the cable 24 in clamp 10. It is also noted that the clamp 10 can be used to secure a single-strand cable by way of a completely and originally separate securing wire used to wind around the body to seal off the trough.

Use of the clamp 10 to secure the cable 24 to a structure relieves stress from any connection between the cable and a structure (such as a pole or building), while also leaving sufficient tension on the aerial span. The features of the present invention as embodied in the clamp 10 also provide a simple method to attach the cable to the pole and/or to alter the direction of the cable with minimal tension or stress on the line. Any type of hook, eyelet, bracket or any other conventional attachment structure can be employed to attach the clamp 10 to a structure. In addition, the clamp 10 may also be used to attach a cable mid-span to a support wire that spans between structures, such as between poles or a pole and building.

The wire hanger 14 extends from the front of the body 12 and consists of two parallel extensions 34 that terminate at the loop 28. The loop 28 consists of two outward flared extensions 36 and an interconnecting arcuate portion 38. To attach the wire hanger 14 to the body 12, the end portions 40 of each extension 34 are looped into and around a forward portion 42 of the body 12 rolled backwards toward the rear of the body 12. More specifically, each end 40 is bent so that a first end segment 40a extends through two aligned holes 44 and 46, and a second end segment 40b is bent to extend around and outside the body 12 to be generally parallel to the first end segment 40a. This is the same for the end portions 40 of each extension 34.

The wire hanger 14 should be sized sufficiently large enough for convenient attachment. For example, the wire hanger 14 may extend from the body 12 two to three inches. The radius of curvature of the arcuate portion 38 may be about being about 0.375 inches to 0.500 inches. The wire hanger 14 may be constructed of any suitable material with the required tensile strength for the desired application. For example, for supporting a common coaxial cable for CATV, the wire hanger material can be 0.80 inch diameter 300 series stainless steel wire.

As mentioned above, the body 12 includes the first side wall 16 and the second side wall 18, which are interconnected by the base wall 20 to from the trough 22 that receives the cable 24. The trough 22 has an elongated shape that is longer than its opening through which the cable 24 is inserted into the trough 22. The walls 16, 18 and 20 are generally parallel and perpendicular to one another. The trough 22 is to be sized large enough to receive a cable in a loose fashion so as not to damage or otherwise effect the signal-carrying ability of the cable. For example, the depth of the trough 22 may be in the approximate range of 0.600 inches to 1.350 inches, the width may be in the approximate range of 0.400 inches to 0.600 inches, and the length may be in the approximate range of 1.50 inches to 2.80 inches.

The first side wall 18 extends forward beyond the trough 22 to form the roll-over extension 42 used to attach the wire hanger 14. More specifically, the roll-over extension 42 curves back towards the body 12 to form a loop outside the trough 22. The loop can take on any cross-section, such as generally rectangular, generally oval or circular and can have a variety of radius of curvatures, including, for example, in the approximate range of 0.050 inches to 0.280 inches.

As mentioned above, the roll-over extension 42 defines holes 46 on the outer side of the loop and holes 44 on the inner side of the loop. The holes 44 and 46 are designed to receive the first end segments 40a of the end portions 40 of the extensions 34 of the wire hanger 14. The roll-over extension 42 includes an outer arcuate surface 48 that guides the separated portion 32a of the messenger wire 32 from the signal-carrying wire 30 back around to be wound about the body 12 using the notches 26a-c (and notch 26d when present) to secure the cable 24 in the trough 22.

The elongated opening of the trough 22 is bounded by a first elongated side edge 50 of the first side wall 16 and a second elongated side edge 52 of the second side wall 18. The first elongated edge 50 is curved outward from the trough 22. This outward curvature assists in inserting the cable 24 into the trough 22 and in winding, locating and securing the separated portion 32a of the messenger wire 32. The second elongated edge 52 may be in the same plane as the second side wall 18 or can also be curved outward for the same reasons. The radius of curvature may any suitable dimension, including, for example, in the approximate range of 0.150 inches to 0.240 inches.

The ends of the trough 22 are bounded by front edge 54 and rear edge 56. The front edge 54 traces the front end of the trough 22 at the first and base walls 16 and 20 and curves outward from the trough. The rear edge 56 traces the rear end of the trough 22 at the first, second and base walls 16, 18 and 20 and also curves outward from the trough 22. The end edges 54 and 56 are curved so as to minimize potential for damage to the cable. The degree curvature of curvature can be any acceptable amount, including, for example, in the approximate range of 0.075 inches to 0.120 inches.

The front edge 54 defines one notch 26b in the first side wall 16 adjacent the first elongated side edge 50 of the first side wall 16. The rear edge 56 defines one notch 26a in the first side wall 16 adjacent the first elongated side edge 50 of the first side wall 16 and another notch 26c in the second side wall 18 adjacent the second elongated side edge 52 of the second side wall 18. Each of these notches 26a-26c are sized sufficiently large enough to receive at least two windings of a conventional messenger or other securing wire and have a slightly rectangular shape extending longitudinally. For example, the width (including the opening) may be approximately 0.150 inches, and the length may be in the approximate range of 0.160 inches to 0.500 inches.

In addition, when present, the side edge 52 defines the front notch 26d in the second side wall 18 adjacent the rear portion of the hanger 14. If the optional notch 26d is present, it should also be sized appropriately to receive at least two windings of a conventional messenger or other securing wire. Although not necessary, the notch 26d preferably has an “L” shape with the major portion extending longitudinally, for example, with a length of approximately 0.160 inches and a width of about 0.150 inches.

Each of the notches 26a-c (and notch 26d when present) includes an arcuate flange 58 at its end that curves inward into the trough 22 and longitudinally along the elongated direction of the body 12. The flanges 58 guide the separated messenger or other securing wire 32a through the notches 26a-c (and notch 26d when present) and provide a smooth surface upon which to wind the wire so as not to damage the wire. The flange 58 may be formed of material cut to form the notch and rolled back over into the trough 22. The flanges 58 may be curved back inward at any suitable radius of curvature, including for example in the approximate range of 0.040 inches to 0.070 inches. The body 12 of the clamp may be constructed of any suitable material, such as, for example, 0.032 inch stainless steel or 0.50 inch 6061 aluminum.

In FIG. 2, an exemplary winding pattern is shown for the separated messenger wire 32a to secure the cable 24 in the trough 22 of the clamp 10. As mentioned above, the cable 24 is double-stranded with a larger diameter signal-carrying wire 30 and the attached smaller diameter support and/or messenger wire 32. To utilize the clamp 10, the portion 32a of the messenger wire 30 is separated from the signal carrying wire 30. Then, the cable 24 adjacent the separated messenger wire portion 32a is inserted into the trough 22. Next, the separated messenger wire 32a is threaded through a gap 60 located between the parallel wire extensions 34 and encircled around the rolled extension 42 over the arcuate surface 48 back toward the body 12. Finally, the messenger wire 32a is wound along the body portion 12 of the clamp using the notches 26a-c (and notch 26d when present). Any pattern of winding can be employed at the users preference.

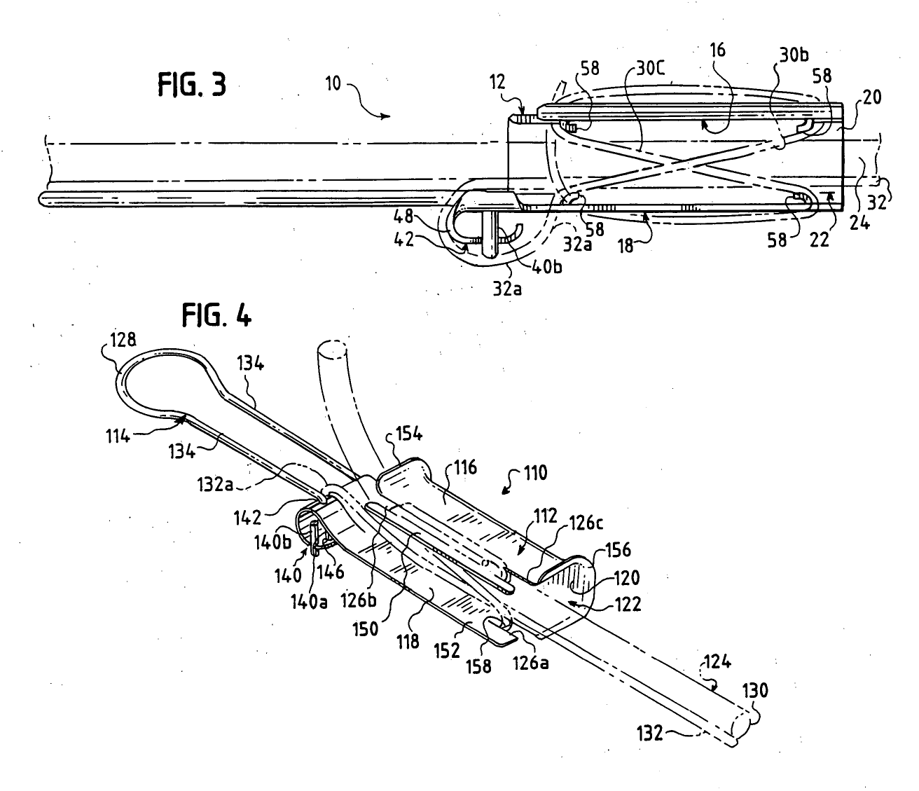

The winding pattern should include at least one segment that extends across the opening of the trough 22. More specifically, the wrapping procedure, when complete, will preferably cross the opening of the trough 22 in multiple locations. For example, FIG. 2 illustrates a configuration in which the separated messenger wire 32a has two segments 30b and 30c that cross the trough 22 in two different places perpendicular to the longitudinal axis of the body 12 and trough 22. In FIG. 3, there is illustrated another wrapping pattern for the separated messenger wire 32a in which portions 30b and 30c criss-cross one another across the opening of the trough 22. Although FIGS. 2 and 3 illustrate wrapping patterns for the separated messenger wire, other patterns are certainly possible, and such configurations may result in more or less locations of the separated messenger wire crossing the trough 22.

A benefit of a clamp embodying features of the present invention is the convenient and effective winding of the separated messenger or other securing wire without having to shift the clamp from hand to hand. More specifically, the body 12 of the clamp 10 can be held in one hand while the complete winding of the separated messenger wire can be done with the other hand. For example, the body 12 can be held in the left hand with the thumb on the second side wall 18 and the other fingers on the first side wall 16. The separated messenger wire 30a can be wound around the body 12 at the notches 26a-c (and notch 26d when present) in a generally counter-clockwise direction with the right hand. The hands also can be reversed. That is, the body 12 can be held by the right hand with the thumb on the first side wall 16 and the other fingers on the second side wall 18, and the winding can be done by the left hand in a generally counter clockwise direction.

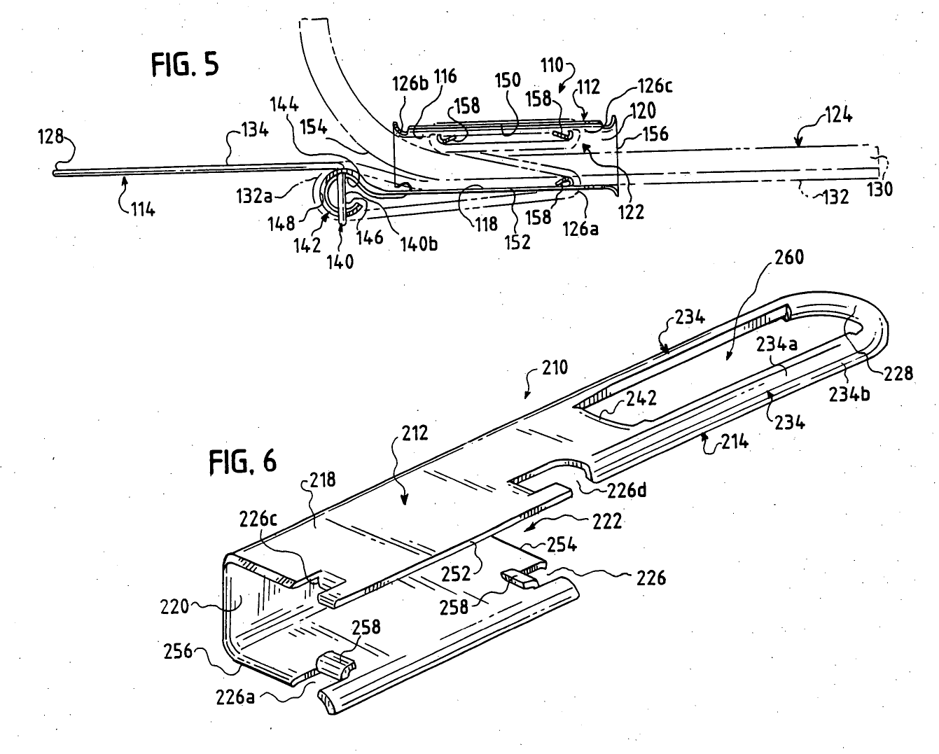

Referring to FIGS. 4 and 5, another two-piece clamp 110 is illustrated embodying features of the present invention. The clamp 110 is similar to the previously discussed clamp 10 with a few minor variations as are evident from the figures. The clamp 110 includes a body 112 and a wire hanger 114. The body includes a first elongated side wall 116 and a second elongated side wall 118 interconnected by an elongated base wall 120. The walls 116, 118, 120 define a cavity or trough 122 that is sized to accept in a generally loose fitting fashion a conventional signal-carrying cable 124. The first side wall 116 includes a rear notch 126c and a front notch 126b. The second side wall 118 includes a rear notch 126a. The notches 126a-c open in a direction designed to facilitate expeditious and effective securement of the cable 124 in the clamp 110. The wire hanger 114 includes a loop 128 that enables the clamp 110 to be easily suspended from a hook or other conventional attachment to structure, such as a pole or building.

More specifically, the clamp 110 can be employed to support and direct, in a suspended fashion, the cable 124, which can be a double-stranded cable with a signal-carrying wire 130 and an attached support wire or messenger wire 132. To attach the cable 124 to the clamp 110, a portion 132a of the messenger wire 132 is separated from the signal carrying wire 130. The trough 122 of the clamp 110 receives the cable 124 (both the signal-carrying wire 130 and the messenger wire 132), and the separated portion 132a of the messenger wire 132 is used to close off the opening of the trough 122 to secure the cable 124 in the trough 122.

To secure the opening of the trough 122, the separated portion 132a of the messenger wire 132 is wound along the body 112 using the notches 126a-c to maintain its position relative to the body 112. Due to the positioning, orientation and configuration of the notches 126a-c, the winding of the separated messenger wire portion 132a can be accomplished quickly and efficiently without having to shift the clamp 110 and wire portion 132a from hand-to-hand. Moreover, as discussed above, a variety a winding patterns between the separated messenger wire portion 132a and the notches 126a-c can be employed in securing the cable 124 in clamp 110.

The wire hanger 114 extends from the front of the body 112 and consists of two parallel extensions 134 that terminate at the loop 128. To attach the wire hanger 114 to the body 112, the end portions 140 of each extension 134 are looped into and around a forward portion 142 of the body 112 rolled backwards toward the rear of the body 112. More specifically, each end 140 is bent so that a first end segment 140a extends through two aligned holes 144 and 146, and a second end segment 140b is bent to extend around and outside the body 112 to be generally parallel to the first end segment 140a. This is the same for the end portions 140 of each extension 34.

As mentioned above, the body 112 includes the first side wall 116 and the second side wall 118, which are interconnected by the base wall 120 to form the trough 122 that receives the cable 124. The trough 122 has an elongated shape that is longer than its opening through which the cable 124 is inserted into the trough 122. The walls 116, 118 and 120 are generally parallel and perpendicular to one another. As mentioned above, the trough 122 is to be sized large enough to receive a cable in a loose fashion so as not to damage or otherwise effect the signal-carrying ability of the cable.

The first side wall 118 extends forward beyond the trough 122 to form the roll-over extension 142 used to attach the wire hanger 114. More specifically, the roll-over extension 142 curves back towards the body 112 to from a loop outside the trough 122. The loop can take on any cross-section, and as illustrated has s circular cross-section.

As mentioned above, the roll-over extension 142 defines holes 146 on the outer side of the loop and holes 144 on the inner side of the loop. The holes 144 and 146 are designed to receive the first end segments 140a of the end portions 140 of the extensions 134 of the wire hanger 114. The roll-over extension 142 includes an outer arcuate surface 148 that guides the separated portion 132a of the messenger wire 132 from the signal-carrying wire 130 back around to be wound about the body 112 using the notches 126a-c to secure the cable 124 in the trough 122.

The elongated opening of the trough 122 is bounded by a first elongated side edge 150 of the first side wall 116 and a second elongated side edge 152 of the second side wall 118. The first elongated edge 150 is curved outward from the trough 122. This outward curvature assists in inserting the cable 124 into the trough 122 and in winding, locating and securing the separated portion 132a of the messenger wire 132. The second elongated edge 152 may be in the same plane as the second side wall 118 or can also be curved outward for the same reasons.

The ends of the trough 122 are bounded by front edge 154 and rear edge 156. The front edge 154 traces the front end of the trough 122 at the first and base walls 116 and 120 and curves outward from the trough 122. The rear edge 156 traces the rear end of the trough 122 at the first, second and base walls 116, 118 and 120 and also curves outward from the trough 122. The end edges 154 and 156 are curved so as to minimize potential for damage to the cable.

The front edge 154 defines one notch 126b in the first side wall 116 adjacent the first elongated side edge 150 of the first side wall 116. The rear edge 156 defines one notch 126c in the first side wall 116 adjacent the first elongated side edge 150 of the first side wall 116 and another notch 126a in the second side wall 118 adjacent the second elongated side edge 152 of the second side wall 118. Each of these notches 126a-126c are sized sufficiently large enough to receive at least two windings of a conventional messenger or other securing wire and have a slightly rectangular shape extending longitudinally.

Each of the notches 126a-c includes an arcuate flange 158 at its end that curves inward into the trough 122 and longitudinally along the elongated direction of the body 112. The flanges 158 guide the separated messenger or other securing wire 132a through the notches 126a-c and provide a smooth surface upon which to wind the wire so as not to damage the wire.

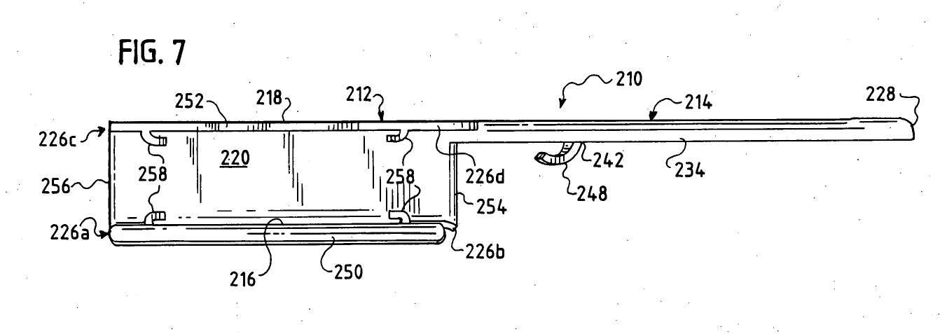

Referring to FIGS. 6 and 7, a one-piece clamp 210 is illustrated embodying features of the present invention. The alternate clamp 210 includes a body 212 having an integrally extending hanger 214. The body 212 includes a first elongated side wall 216 and a second elongated side wall 218 interconnected by an elongated base wall 220. The walls 216, 218 and 220 define a cavity or trough 222 that is sized to accept in a generally loose fitting fashion a conventional signal-carrying cable, such as the cable 24 or 124 discussed above for the two-piece clamps 10 and 110. The first side wall 216 includes a rear notch 226a and a front notch 226b. The second side wall 218 includes a rear notch 226c, and optionally, it may include a front notch 226d. The notches 226a-c (and notch 226d when present) open in a direction designed to facilitate expeditious and effective securing of a cable in the clamp 210. The wire hanger 214 includes a loop 228 that enables the clamp 210 to be easily suspended from a hook or other conventional attachment to structure, such as a pole or building.

More specifically, the clamp 210 can be employed to support and direct, in a suspended fashion, a cable, such as cable 24 (which is a double-stranded cable with a signal-carrying wire and an attached support wire or messenger wire). A cable is attached to the clamp 210 is the same manner as to the previously discussed two-piece clamps 10 and 110. That is, for example, a separated portion of the messenger wire is wound along the body 212 using the notches 226a-c (and, optionally, notch 226d when present) to maintain the wire in position relative to the body 212. Due to the positioning, orientation and configuration of the notches 226a-c (and notch 226d when present), the winding of the separated messenger wire portion can be accomplished quickly and efficiently without having to shift the clamp 210 and wire portion from hand-to-hand. Moreover, as discussed above for the two-piece clamps, a variety a winding patterns between the separated messenger wire portion and the notches 226a-c (and notch 226d when present) can be employed in securing a cable in clamp 210.

The hanger 214 extends from the front of the body 212. More specifically, the hanger 214 extends integrally from the second elongated side wall 218 and includes two parallel extensions 234 that terminate at the loop 228. Each of the extensions 234 has an L-shaped cross-section formed by an inner side 234a being generally perpendicular to an outer side 234b. The loop 228 can have a generally circular cross-section. This construction adds strength to the hanger 214.

As mentioned above, the body 212 includes the first side wall 216 and the second side wall 218, which are interconnected by the base wall 220 to from the trough 222 that receives a cable, such as cable 24. The trough 222 has an elongated shape that is longer than its opening through which a cable, such as cable 24, is inserted into the trough 222. The walls 216, 218 and 220 are generally parallel and perpendicular to one another. As mentioned above, the trough 222 is to be sized large enough to receive a cable in a loose fashion so as not to damage or otherwise effect the signal-carrying ability of the cable. The two extensions 234 and the loop 228 form an elongated, generally oval gap 260. At the rear of the gap 260, there is an arcuate edge 242. More specifically, the arcuate edge 242 curves back towards the body 212 to from a loop. The loop can take on any cross-section, and as illustrated has a circular cross-section. The arcuate edge 242 is also curved as it extends between the two extensions 234. The arcuate edge 242 also includes an outer arcuate surface 248 that guides the separated portion of the messenger wire or other securing wire back around to be wound about the body 212 using the notches 226a-c (and notch 226d when present) to secure a cable in the trough 222.

The elongated opening of the trough 222 is bounded by a first elongated side edge 250 of the first side wall 216 and a second elongated side edge 252 of the second side wall 218. The first elongated edge 250 is curved outward from the trough 222. This outward curvature assists in inserting a cable into the trough 222 and in winding, locating and securing the separated portion of a messenger or other securing wire. The second elongated edge 252 may be in the same plane as the second side wall 218 or can also be curved outward for the same reasons.

The ends of the trough 222 are bounded by front edge 254 and rear edge 256. The front edge 254 traces the front end of the trough 222 at the first and base walls 216 and 220 and curves outward from the trough 222. The rear edge 256 traces the rear end of the trough 222 at the first, second and base walls 216, 218 and 220 and also curves outward from the trough 222. The end edges 254 and 256 are curved so as to minimize potential for damage to the cable.

The front edge 254 defines one notch 226b in the first side wall 216 adjacent the first elongated side edge 250 of the first side wall 216. The rear edge 256 defines one notch 226a in the first side wall 216 adjacent the first elongated side edge 250 of the first side wall 216 and another notch 226c in the second side wall 218 adjacent the second elongated side edge 252 of the second side wall 218. Each of these notches 226a-226c are sized sufficiently large enough to receive at least two windings of a conventional messenger or other securing wire and have a slightly rectangular shape extending longitudinally. In addition, when present, the side edge 252 defines the front notch 226d in the second side wall 218 adjacent the rear portion of the hanger 214.

Each of the notches 226a-c (and notch 226d when present) includes an arcuate flange 258 at its end that curves inward into the trough 222 and longitudinally along the elongated direction of the body 212. The flanges 258 guide a separated messenger or other securing wire through the notches 226a-c (and notch 226d when present) and provide a smooth surface upon which to wind the wire so as not to damage the wire. The wire wrapping patterns discussed above for the two-piece clamps 10 and 110 apply to the one-piece clamp 210 as well.

As mentioned above, in some instances it is desirable to prevent electrical contact between the drop wire clamp and the attachment point on the structure to which it has been attached. Thus, the drop wire clamp is electrically insulated from the attachment point using an insulator. The insulator has properties such that it is able to withstand both the high weight loads and forces on the contact point between the drop wire clamp and the attachment point and the slight swinging or rubbing action between the drop wire clamp and the attachment point caused by things such as the wind.

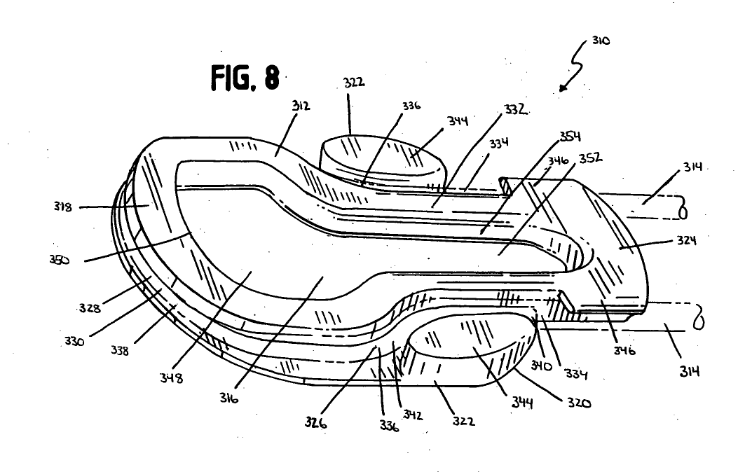

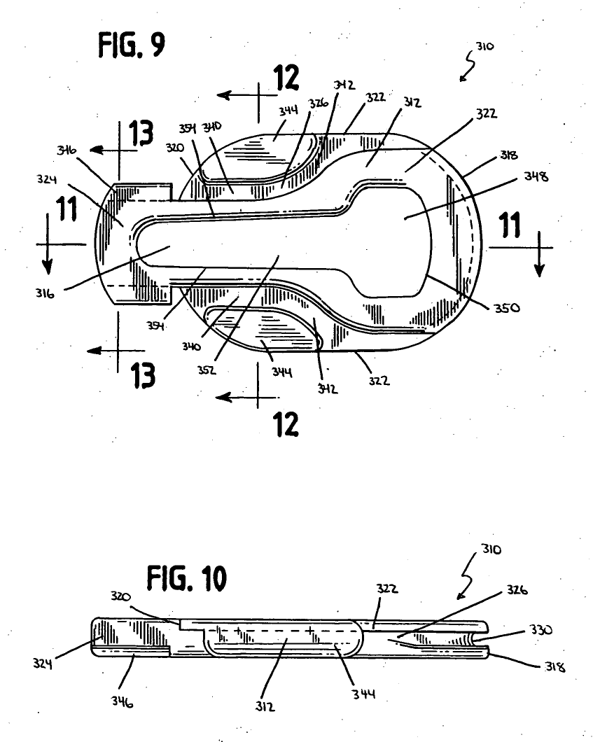

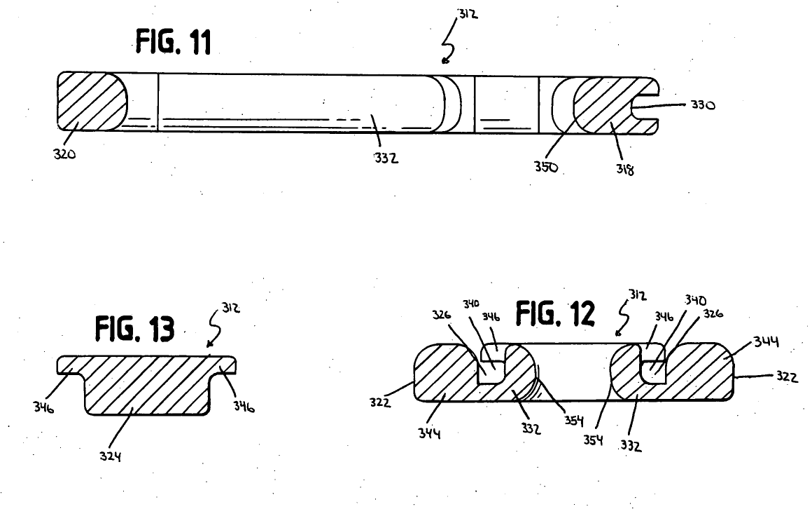

Referring to FIGS. 8-13, there is illustrated an example of an insulating insert 310 which may be used in conjunction with the drop wire clamp 10, 110, or 210 to prevent an electrical connection between the drop wire clamp and the attachment point on the building, wall, pole, or other similar structure to which the drop wire clamp is attached. The insert 310 includes a body 312, which defines an aperture 316 for receiving the attachment structure, such as a hook or other suitable fastener, at the attachment point. The body 312 includes a first generally arcuate end 318 and a second generally arcuate end 320 opposite the first generally arcuate end 318. The first generally arcuate end 318 and second generally arcuate end 320 are interconnected by a pair of parallel sides 322. The body 312 also includes an extended portion 324 which extends outward from the second generally arcuate end 320.

The body 312 also defines a channel 326 for receiving the hanger portion 314 of the drop wire clamp. More specifically, the first generally arcuate end 318 defines an outward opening arcuate channel portion 330 of the channel 326 for receiving an arcuate portion 338 of the loop 328 of the hanger 314. The side 322 include an inner portion 332 and a pair of outer portions 344, the later being located adjacent the interconnection between the side edges 322 and the second generally arcuate end 320, which are separated by the channel 326. The inner portion 332 and the outer portions 344 define a pair of flared channel portions 342 and a pair of parallel channel portions 340. The channel 326 includes the flared channel portions 342 and the parallel channel portions 340. The flared channel portions 342 receive flared extensions 336 of the hanger 314, and the parallel channel portions 340 receive parallel extensions 334 of the hanger 314. Moreover, the shape of the inner portion 332 of the body 312 generally corresponds to the shape of the hanger 314, such that the hanger 314 may be generally adjacent the inner portion 332.

The extended portion 324 includes a pair of opposing projections 346. The projections 346 receive the parallel extensions 334 of the hanger 314.

The aperture 316 includes an enlarged portion 348 defined by an arcuate edge 350 of the first generally arcuate end 318 of the body 312. The aperture 316 further includes an elongated portion 352 adjacent parallel edges 354 of the inner body portion 332. The aperture 316 is sized such that the attachment structure, such as a hook or other fastener, of the attachment point may be received by the aperture 316.

The insert 310 is preferably made of polyurethane or polyurethane 75D, but may be made using of any material having sufficient electrical insulation (preferably of approximately 800 volts/mil or higher), tensile strength (preferably of 7500 psi or higher), hardness (preferably a hardness (Shore D) of 95 or higher), and impact resistence (preferably of 160 in/lbs or higher).

The insert 310 may be used in conjunction with any suitable drop wire clamp, such as those discussed above and identified with reference numerals 10, 110, or 210 herein. In order to connect the insulating insert 310 to the hanger portion 314 of the drop wire clamp, either: (1) the projections 346 of the extended portion 324 of the insert 310 may be extended through the loop 328 of the hanger 314 and then may be moved toward the parallel extensions 334, such that the projections 324 receive the parallel extensions 334; or (2) the insert 310 may be extended between the parallel extensions 334 and through the hanger 314 at an angle and then the insert 310 may be twisted to cause the projections 346 to receive the parallel extensions 334. Thereafter, the insert 310 may be moved such that the parallel extensions 334 correspond with the parallel channel portions 340 and the flared extensions 336 correspond with the flared channel portions 342. The insert 310 then may be pressed into engagement with the hanger 314 such that the parallel extensions 334 are received by the parallel channel portions 340 and the flared extensions 336 are received by the flared channel portions 342. If necessary, the insert 310 may be forced or pressed toward the arcuate portion 338 of the hanger 314, such that the arcuate portion 338 is received by the arcuate channel portion 330. The channel 326, the inner portion 332 of the body 312, and the outer portions 344 of the body 312 are sized so that the insert 310 tightly engages the hanger 314.

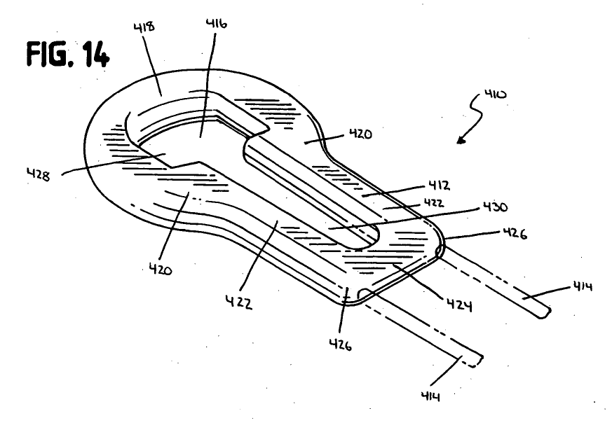

While the insert 312 may be used with preexisting drop wire clamps, it may also be desirable to provide a drop wire clamp having a molded insulator 410 surrounding the hanger 414 of the drop wire clamp, such that a separate insulating insert is unnecessary, as illustrated in FIG. 14. The molded insulator 410 includes a body 412 which surrounds, or encapsulates, a portion of the hanger 414 of the drop wire clamp and which defines an aperture 416 for receiving the attachment structure. The body 412 includes an arcuate portion 418, a pair of flared portions 420, a pair of parallel portions 422, and an interconnecting portion 424. The arcuate portion 418 surrounds the interconnecting arcuate portion of the hanger 414, the flared portions 420 surround the flared extensions of the hanger 414, and the parallel portions 422 surround the parallel extensions of the hanger 414. The parallel portions 422 extend partially over the length of the parallel extensions of the hanger 414, but do not extend to the body portion of the drop wire clamp. The interconnecting portion 424 connects the terminal ends 426 of the parallel portions 422.

The aperture 416 includes an enlarged portion 428 adjacent the arcuate portion 418 of the body 412. The aperture 416 further includes an elongated portion 430 adjacent parallel portions 422 of the body 412 and the interconnecting portion 424. The aperture 416 is sized such that the attachment structure, such as a hook or other fastener, of the attachment point may be received by the aperture 416.

The molded insulator 410 is preferably made of polyurethane or polyurethane 75D, but may be made using of any material having sufficient electrical insulation (preferably of approximately 800 volts/mil or higher), tensile strength (preferably of 7500 psi or higher), hardness (preferably a hardness (Shore D) of 95 or higher), and impact resistence (preferably of 160 in/lbs or higher). The molded insulator 410 may be molded onto the hanger 414 of the drop wire clamp in any manner known to those skilled in the art.

Additionally, in some cases it may be desirable to electrically insulate the drop wire clamp from the attachment point by providing the attachment structure, such as a hook or other fastener, of the attachment point with a layer of insulation, rather than using the insulated insert 310 or the molded insulator 410. In such a case, the attachment structure is provided with a coating of an insulator material which adheres to the surface of the attachment structure. Preferably, the coating for the attachment structure is an epoxy powder fluidized bed coating (such as that available from Plastic Coating Corp., Milwaukee, Wis.). However, the coating may consist of any material which adheres to the attachment structure and has sufficient electrical insulation (preferably of approximately 800 volts/mil or higher), tensile strength (preferably of 7500 psi or higher), hardness (preferably a hardness (Shore D) of 95 or higher), and impact resistence (preferably of 160 in/lbs or higher). If an epoxy powder fluidized bed coating is utilized, the powder is applied by dipping the heated attachment structure in an aerated powder bed. The powder melts on the hot attachment structure and forms a continuous plastic film encapsulating the attachment structure. Likewise, if another suitable material is used as the coating material, the coating may be applied in any manner known by those skilled in the art.

It will be understood that various changes in the details, materials, and arrangements of parts and components which have been herein described and illustrated in order to explain the nature of the invention may be made by those skilled in the art within the principle and scope of the invention as expressed in the appended claims.

What is claimed is:

1. A support to attach and suspend cable, wire, rope and any other elongated member from a structure comprising:
a body configured to attach to a cable, wire, rope or any other elongated member;
a hanger to mount and support the body from a structure; and
an insulator in communication with at least a portion of one of the hanger and the body to electrically insulate between the support and a structure to which the support is attached.

2. A support in accordance with claim 1 wherein the insulator is capable of being mechanically joined with at least a portion of one of the hanger and the body.

3. A support in accordance with claim 1 wherein the insulator is molded to at least a portion of one of the hanger and the body.

4. A support in accordance with claim 1 wherein the hanger comprises at least a hook portion to attach to a structure.

5. A support in accordance with claim 4 wherein the insulator traces at least a portion of the hook portion.

6. A support in accordance with claim 5 wherein the insulator is capable of being mechanically joined with at least a portion of the hook portion.

7. A support in accordance with claim 6 wherein the insulator defines at least one slot to receive at least a portion of the hook portion in mechanically joining the insulator to the hanger.

8. A support in accordance with claim 7 wherein the hanger includes at least a pair of side portions that support the hook portion.

9. A support in accordance with claim 8 wherein the at least one slot receives at least a portion of the hook portion and at least a portion of one of the at least a pair of side portions in mechanically joining the insulator to the hanger.

10. A support in accordance with claim 9 wherein the at least one slot opens in at least two different directions.

11. A support in accordance with claim 8 wherein the at least one slot comprises at least two slots and at least one of the two slots receives at least a portion of the hook portion and another of the at least two slots receives at least a portion of one of the at least a pair of side portions in mechanically joining the insulator to the hanger.

12. A support in accordance with claim 11 wherein the at least two slots open in at least two different directions.

13. A support in accordance with claim 12 wherein the insulator further comprises a cross-link portion extending between at least two of the at least a pair of side portions.

14. A support in accordance with claim 13 wherein the cross-link portion includes at least one projection configured to engage at least one of the at least a pair of side portions.

15. A support in accordance with claim 13 wherein the insulator defines an aperture.

16. A support in accordance with claim 15 wherein the insulator comprises material of at least polyurethane.

17. A support in accordance with claim 5 wherein the insulator is molded to at least a potion of the hook portion.

18. A support in accordance with claim 17 wherein the hanger includes at least a pair of side portions that support the hook portion.

19. A support in accordance with claim 18 wherein the insulator is molded to at least a portion of the hook portion and at least a portion of at least one of the at least a pair of side portions.

20. A support in accordance with claim 19 wherein the insulator further comprises a cross-link portion extending between at least two of the at least a pair of side portions.

21. A support in accordance with claim 20 wherein the insulator defines an aperture.

22. A support in accordance with claim 21 wherein the insulator comprises material applied from an epoxy powder fluidized bed coating.
